(19) United States
(12) Patent Application Publication
(10) Pub. No.: US 2024/0224167 A1
(43) Pub. Date: Jul. 4, 2024

(54) SYSTEM AND METHOD FOR AUTOMATIC GENERATION AND IMPLEMENTATION OF NETWORK SLICE IDENTIFIER

(71) Applicant: Rakuten Mobile, Inc., Tokyo (JP)

(72) Inventors: Mohit LUTHRA, Singapore (SG); Jithin CHATHANKANDATH, Tokyo (JP)

(21) Appl. No.: 17/998,259

(22) PCT Filed: Aug. 29, 2022
(86) PCT No.: PCT/US2022/041825

§ 371 Date: Nov. 9, 2022

(51) Int. Cl. H04W 48/18; H04W 48/14

(52) U.S. Cl. CPC H04W 48/18; H04W 48/14

(57) ABSTRACT

A method includes creating, by a processor and based on a network slice design submitted by a user, a network slice; and generating, automatically by the processor, a network slice selection assistance information ID (nSSAI ID) for the network slice.

### TECHNICAL FIELD

This description relates to a system for automatic generation and implementation of a network slice identifier and method of using the same.

### BACKGROUND

A cellular network is a telecommunication system of mobile devices (e.g., mobile phone devices) that communicate by radio waves through one or more local antenna at a cellular base station (e.g., cell tower). The coverage area in which service is provided is divided into small geographical areas called cells. Each cell is served by a separate low-power-multichannel transceiver and antenna at the cell tower. Mobile devices within a cell communicate through that cell's antenna on multiple frequencies and on separate frequency channels assigned by the base station from a pool of frequencies used by the cellular network.

A radio access network (RAN) is part of the telecommunication system and implements radio access technology. RANs reside between a device, such as a mobile phone, a computer, or remotely controlled machine, and provides connection with a core network (CN). Depending on the standard, mobile phones and other wireless connected devices are varyingly known as user equipment (UE), terminal equipment (TE), mobile station (MS), and the like.

### SUMMARY

In some embodiments, a method includes creating, by a processor and based on a network slice design submitted by a user, a network slice; and generating, automatically by the processor, a network slice selection assistance information ID (nSSAI ID) for the network slice.

In some embodiments, an apparatus includes a processor; and a memory having instructions stored thereon that, when executed by the processor, cause the processor to create, based on a network slice design submitted by a user, a network slice; and generate, automatically based on the network slice design, a network slice selection assistance information ID (nSSAI ID) for the network slice.

In some embodiments, a non-transitory computer readable medium having instructions stored thereon that, when executed by a processor, cause the processor to create, based on a network slice design submitted by a user, a network slice; and generate, automatically based on the network slice design, a network slice selection assistance information ID (nSSAI ID) for the network slice.

### BRIEF DESCRIPTION OF THE DRAWINGS

Aspects of the present disclosure are understood from the following detailed description when read with the accompanying FIGS. In accordance with the standard practice in the industry, various features are not drawn to scale. In some embodiments, dimensions of the various features are arbitrarily increased or reduced for clarity of discussion.

FIG. 1 is a diagrammatic representation of a system for network slice design (NSD), in accordance with some embodiments.

FIG. 2 is a flow diagram of method for designing a network slice, in accordance with some embodiments.

FIGS. 3-15 are graphic user interfaces (GUIs) for designing a network slice, in accordance with some embodiments.

FIG. 16 is a data flow diagram of a method for generation and implementation of a unique network slice identifier (UNSI), in accordance with some embodiments.

FIG. 17 is an example nSSAI ID rule, in accordance with some embodiments.

FIG. 18 is a high-level functional block diagram of a processor-based system, in accordance with some embodiments.

### DETAILED DESCRIPTION

The following disclosure provides many different embodiments, or examples, for implementing distinctive features of the discussed subject matter. Examples of components, values, operations, materials, arrangements, or the like, are described below to simplify the present disclosure. These are, of course, examples and are unintended to be limiting. Other components, values, operations, materials, arrangements, or the like, are contemplated. For example, the formation of a first feature over or on a second feature in the description that follows include embodiments in which the first and second features are formed in direct contact, and further include embodiments in which additional features are formed between the first and second features, such that the first and second features are unable to be in direct contact. In addition, the present disclosure repeats reference numerals and/or letters in the numerous examples. This repetition is for the purpose of simplicity and clarity and is unintended to dictate a relationship between the various embodiments and/or configurations discussed.

Further, spatially relative terms, such as beneath, below, lower, above, upper and the like, are used herein for ease of description to describe one element or feature's relationship to another element(s) or feature(s) as illustrated in the FIGS. The spatially relative terms are intended to encompass different orientations of the device in use or operation in addition to the orientation depicted in the FIGS. The apparatus is otherwise oriented (rotated 90 degrees or at other orientations) and the spatially relative descriptors used herein likewise are interpreted accordingly.

In some embodiments, automatic generation and implementation of a unique network slice identifier (UNSI) is discussed in the present disclosure. In some embodiments, a slice identifier is generated automatically, which provides ease of network slice management, slice identifier process efficiency, efficient deployment of a network slice, and a reduction in human error due introduced through manual generation of network slice identifiers.

In other approaches, a unique network slice identifier is generated manually. A manually created unique slice identifier is labor intensive.

Network slicing is a method of creating multiple unique logical and virtualized networks over a common multi-domain infrastructure. Using software-defined networking, network function virtualization, orchestration, analytics, and automation, network operators manually create network slices that support a specific application, service, set of users, or network. Network slices are able to be configured to span multiple network domains, such as an access networks (a user network, such as a RAN, that connects subscribers to a service provider and, through the transport network, to other networks such as the Internet), a CNs (the core network is a central conduit designed to transfer network traffic at high speeds), and a transport networks (the public telecommunications infrastructure which permits telecommunications between and among defined network termination points) deployed across multiple network operators.

Network slicing supports services with varying network requirements, such as a connected vehicle to a voice call, which requires different throughput, latency, and reliability compared to data communication with internet of things (IoT) devices. With network slicing, each slice is configured to have a different architecture, management, and security to support a particular use. While functional components and resources are shared across network slices, capabilities such as data speed, capacity, connectivity, quality, latency, reliability, and services are customized in each slice to conform to a specific service level agreement (SLA) with a vendor. In some embodiments, examples of logic for an auto generated and unique network slice identifier is discussed in the present disclosure.

Single network slice selection assistance information (S-NSSAI) identification (ID) is used to uniquely identify a network slice. The S-NSSAI ID contains two components, the SST (Slice/Service Type) and an optional SD (Slice Differentiator). In relation to network slicing, the SST is the expected behavior of the network slice in terms of specific features and services. Standardized SST values include eMBB (enhanced mobile broadband which focuses on the high speed of end user data and system capacity), URLLC (ultra-reliable low latency communications is a subset of the 5G network architecture that ensures efficient scheduling of data transfers, achieving shorter transmissions through a larger subcarrier, and even scheduling overlapping transmissions) and MIoT (massive internet of things is a category driven by scale rather than speed where deployments include anywhere from hundreds to billions of connected devices where the goal for these applications is to efficiently transmit and consume small amounts of data from vast numbers of devices). In network slicing, the SD is related to the SST and is used as an additional differentiator when multiple network slices carry the same SST value. The SD is directed to the implementation of the network slice.

An nSSAI ID typically has a total length of nine characters where the first three characters are the SST and the remaining six characters are the SD. In some embodiments, a naming manager is configured to take a business rule and implement the business rule in the form of a naming template where the naming manager is responsible for creating an nSSAI ID output in sequence. In some embodiments, the naming manager is a tool, where a naming template is created by the user based on the business rule. In response to the user making a call to that naming template using APIs, the naming manager provides the required inputs to the template to the user and then the naming manager returns the desired output.

In some embodiments, in response to a new network slice being designed, a slice manager automatically makes an application programming interface (API) call to the naming manager and receives an nSSAI ID for the newly designed network slice.

In the event the network slice is deactivated or terminated, then the slice manager makes another API call to the naming manager and requests the revocation of that nSSAI ID from the naming manager, so the terminated or deactivated nSSAI ID is reusable for another slice.

In some embodiments, the naming manager generates a unique nSSAI ID whenever an API call is made to the naming manager from the slice manager. In some embodiments, the naming manager is a template-based rule engine. Within a rule template a user accesses or creates a template rule where the user inputs template parameters. The naming manager is configured to use the rule template to generate the nSSAI ID. Further, the naming manager is configured to maintain a sequence of generated nSSAI IDs or names. In some embodiments, the naming manager is configured to be used for creating the rule templates and generating various nSSAI IDs, application names, or other functions within the scope of the present embodiments.

A network slice is broken up into network service (NS) subnets where each subnet is dedicated to a domain (e.g., RAN, CN, transport domain, or E2E that includes each). The transport domain references the telecommunication transmission facilities under which voice, data, and video communications are distributed between distant locations for use on a shared basis.

Within a NS subnet is one or more network services. For example, within a RAN slice subnet is a network service, such as g node B (gNB is a third-generation partnership project (3GPP) 5G next generation base station which supports 5G new radio). Within a CN slice subnet is a network service, such as NRF (a network repository function which is a function of the 3GPP service-based architecture (SBA) for 5G CNs acting as a central services broker for all network functions in the 5G CN) or AMF (access and mobility management function that receives connection and session related information from the UE for handling connection and mobility management tasks). Within a transport slice subnet is a transport network service.

Within a network service is one or more network functions. For example, within a gNB network service are network functions, such as DU (a distributed unit supports one or more cells supporting radio link control (RLC), medium access control (MAC) and the physical layer), CUCP (central unit control plane hosts radio resource control (RRC) and the control-plane part of the packet data convergence protocol (PDCP)), and CUUP (central unit user plane is a logical node hosting the user plane part of the PDCP protocol of the gNB-CU for a gNB, and the user plane part of the PDCP protocol of the gNB-CU for an en-gNB or a gNB).

Within a NRF network service are network functions, such as MongoDB (an open-source NoSQL database management program), NRF (provides a single record of network functions available in each public land mobile network (PLMN), together with the profile of each and the services supported) and Redis (an in-memory data structure store, used as a distributed, in-memory key-value database, cache, and message broker, with optional durability). Further, within an AMF network service are network functions such as Nginx (an open-source Web server software that performs reverse proxy, load balancing, email proxy, and HTTP cache services), AMF application, and database (DB).

Within a transport network service are network functions, such as software (SW), SDN (software-defined networking is an approach to network management that enables dynamic, programmatically efficient network configurations to improve network performance and monitoring, more like cloud computing than traditional network management), and router (a networking device that forwards data packets between computer networks).

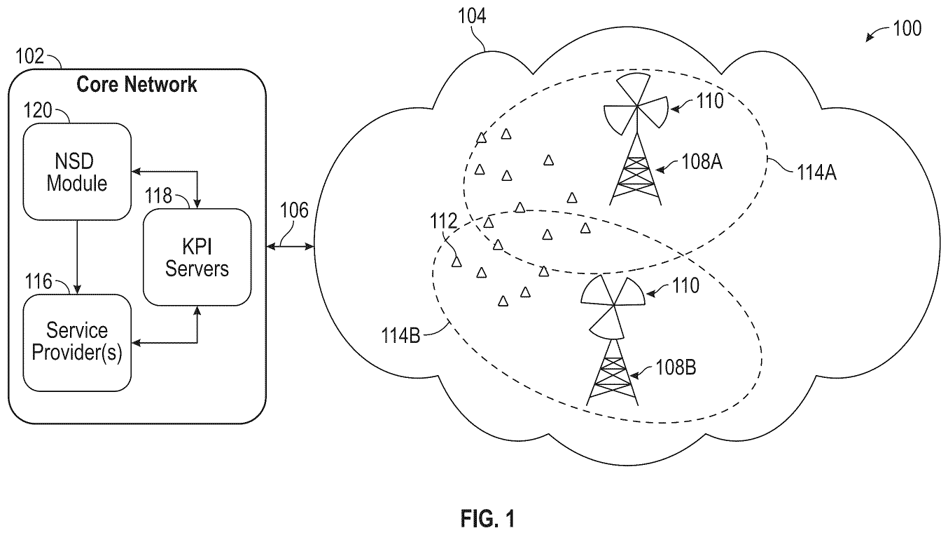

FIG. 1 is a diagrammatic representation of a system for network slice design (NSD) 100, in accordance with some embodiments.

NSD system 100 includes a CN 102 communicatively connected to RAN 104 through transport network 106, which is communicatively connected to base stations 108A and 108B (hereinafter base station 108), with antennas 110 that are wirelessly connected to UEs 112 located in geographic coverage cells 114A and 114B (hereinafter geographic coverage cells 114). CN 102 includes one or more service provider(s) 116, KPI servers 118, and network slice module (NSDM) 120.

CN 102 (further known as a backbone) is domain that is a part of a computer network which interconnects networks, providing a path for the exchange of information between different local area networks (LANs) or subnetworks. In some embodiments, CN 102 ties together diverse networks over wide geographic areas, in different buildings in a campus environment, or in the same building.

In some embodiments, RAN 104 is an access network domain. In some embodiments, RAN 104 is a global system for mobile communications (GSM) RAN, a GSM/EDGE RAN, a universal mobile telecommunications system (UMTS) RAN (UTRAN), an evolved UMTS terrestrial radio access network (E-UTRAN), open RAN (O-RAN), or cloud-RAN (C-RAN). RAN 104 resides between UE 112 (e.g., mobile phone, a computer, or any remotely controlled machine) and CN 102. In some embodiments, RAN 104 is a C-RAN for purposes of simplified representation and discussion. In some embodiments, base band units (BBU) replace the C-RAN.

In conventional distributed cellular networks, equipment at the bottom and top of a base station of a cell site is the BBU. The BBU is radio equipment that links UEs to the CN and processes billions of bits of information per hour. The BBU was traditionally placed in an enclosure or shelter situated at the bottom of a base station. C-RAN, in contrast, uses fiber optic's large signal-carrying capacity to centralize numerous BBUs at a dedicated pool location or a base station. This reduces the quantity of equipment at base stations and provides many other advantages, including lower latency.

In a hierarchical telecommunications network, transport network 106 of NSD system 100 includes the intermediate link(s) between CN 102 and RAN 104. The two main methods of mobile backhaul implementations are fiber-based backhaul and wireless point-to-point backhaul. Other methods, such as copper-based wireline, satellite communications and point-to-multipoint wireless technologies are being phased out as capacity and latency requirements become higher in 4G and 5G networks. Backhaul refers to the side of the network that communicates with the Internet. The connection between base station 108 and UE 112 begins with transport network 106 connected to CN 102. In some embodiments, transport network 106 includes wired, fiber optic, and wireless components. Wireless sections include using microwave bands, mesh, and edge network topologies that use high-capacity wireless channels to get packets to the microwave or fiber links.

In some embodiments, base stations 108 are lattice or self-supported towers, guyed towers, monopole towers, and concealed towers (e.g., towers designed to resemble trees, cacti, water towers, signs, light standards, and other types of structures). In some embodiments, base stations 108 are a cellular-enabled mobile device site where antennas and electronic communications equipment are placed, typically on a radio mast, tower, or other raised structure to create a cell (or adjacent cells) in a network. The raised structure typically supports antenna(s) 110 and one or more sets of transmitter/receivers (transceivers), digital signal processors, control electronics, a remote radio head (RRH), primary and backup electrical power sources, and sheltering. Base stations are known by other names such as base transceiver station, mobile phone mast, or cell tower. In some embodiments, base stations are replaced or supplemented with edge devices configured to wirelessly communicate with UEs. The edge device provides an entry point into service provider CNs, such as CN 102. Examples include routers, routing switches, integrated access devices (IADs), multiplexers, and a variety of metropolitan area network (MAN) and wide area network (WAN) access devices.

In at least one embodiment, antenna(s) 110 are a sector antenna. In some embodiments, antenna(s) 110 are a type of directional microwave antenna with a sector-shaped radiation pattern. In some embodiments, the sector degrees of arc are 60°, 90°, or 1200 designs with a few degrees extra to ensure overlap. Further, sector antennas are mounted in multiples when wider coverage or a full-circle coverage is desired. In some embodiments, antenna(s) 110 are a rectangular antenna, sometimes called a panel antenna or radio antenna, used to transmit and receive waves or data between mobile devices or other devices and a base station. In some embodiments, antenna(s) 110 are circular antennas. In some embodiments, antenna 110 operates at microwave or ultra-high frequency (UHF) frequencies (300 MHz to 3 GHz). In other examples, antenna(s) 110 are chosen for their size and directional properties. In some embodiments, the antenna(s) 110 are MIMO (multiple-input, multiple-output) antennas that send and receive greater than one data signal simultaneously over the same radio channel by exploiting multipath propagation.

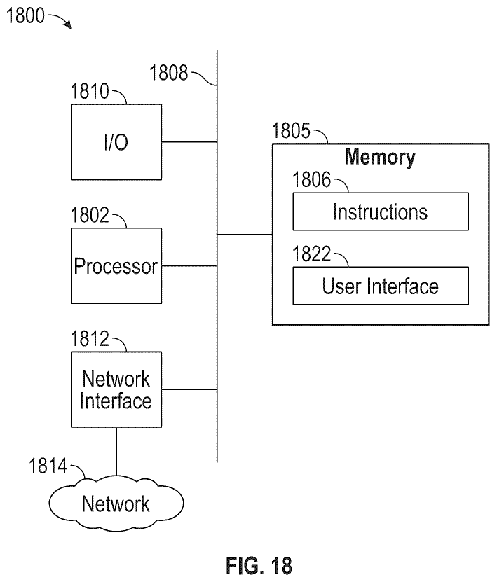

In some embodiments, UEs 112 are a computer or computing system. Additionally, or alternatively, UEs 112 have a liquid crystal display (LCD), light-emitting diode (LED) or organic light-emitting diode (OLED) screen interface, such as user interface (UI) 1822 (FIG. 18), providing a touchscreen interface with digital buttons and keyboard or physical buttons along with a physical keyboard. In some embodiments, UE 112 connects to the Internet and interconnects with other devices. Additionally, or alternatively, UE 112 incorporates integrated cameras, the ability to place and receive voice and video telephone calls, video games, and Global Positioning System (GPS) capabilities. Additionally, or alternatively, UEs run operating systems (OS) that allow third-party apps specialized for capabilities to be installed and run. In some embodiments, UEs 112 are a computer (such as a tablet computer, netbook, digital media player, digital assistant, graphing calculator, handheld game console, handheld personal computer (PC), laptop, mobile Internet device (MID), personal digital assistant (PDA), pocket calculator, portable medial player, or ultra-mobile PC), a mobile phone (such as a camera phone, feature phone, smartphone, or phablet), a digital camera (such as a digital camcorder, or digital still camera (DSC), digital video camera (DVC), or front-facing camera), a pager, a personal navigation device (PND), a wearable computer (such as a calculator watch, smartwatch, head-mounted display, earphones, or biometric device), or a smart card.

In some embodiments, geographic coverage cells 114 include a shape and size. In some embodiments, geographic coverage cells 114 are a macro-cell (covering 1 Km-30 Km), a micro-cell (covering 200m-2 Km), or a pico-cell (covering 4m-200m). In some embodiments, geographic coverage cells are circular, oval (FIG. 1), sector, or lobed in shape, but geographic coverage cells 114 are configured in most any shape or size. Geographic coverage cells 114 represent the geographic area antenna 110 and UEs 112 are configured to communicate.

Service provider(s) 116 are businesses, vendors, customers, or organizations that sell bandwidth or network access to subscribers (utilizing UEs) by providing direct Internet backbone access to Internet service providers and usually access to network access points (NAPs). Service providers are sometimes referred to as backbone providers, Internet providers, or vendors. Service providers include telecommunications companies, data carriers, wireless communications providers, Internet service providers, and cable television operators offering high-speed Internet access.

KPI servers 118 produce both predictions and live network data. Live-network data (KPIs, UE/cell/MDT (minimization of drive test) traces, and crowdsourced data) that allows for modelling of network traffic, hot-spot identification, and radio signal propagation. RF drive testing is a method of measuring and assessing the coverage, capacity, and Quality of Service (QoS) of a mobile radio network, such as RAN 104. The technique consists of using a motor vehicle containing mobile radio network air interface measurement equipment that detects and records a wide variety of the physical and virtual parameters of mobile cellular service in each geographical area. By measuring what a wireless network subscriber experiences in an area, wireless carriers make directed changes to networks that provide better coverage and service to customers. Drive testing commonly is configured with a mobile vehicle outfitted with drive testing measurement equipment. The equipment is usually highly specialized electronic devices that interface to original equipment manufacturer (OEM) mobile handsets (UEs). This ensures measurements are realistic and comparable to actual user experiences. For mobile networks, crowdsourcing methodology leverages a crowd of participants (e.g., the mobile subscribers) to gather network measurements, either manually or automatically through mobile apps, or directly from the network using call traces.

UE/cell/MDT traces collected at the operations support systems (OSS) or through dedicated tools provide service provider(s) 116 with user-level information. Once geo-located, UE/cell/MDT traces are used to enhance path-loss calculations and prediction plots, as well as to identify and locate problem areas and traffic hotspots. KPI servers 118 allow service provider(s) 116 to use UE/cell/MDT traces along with NSDM 120 for network optimization.

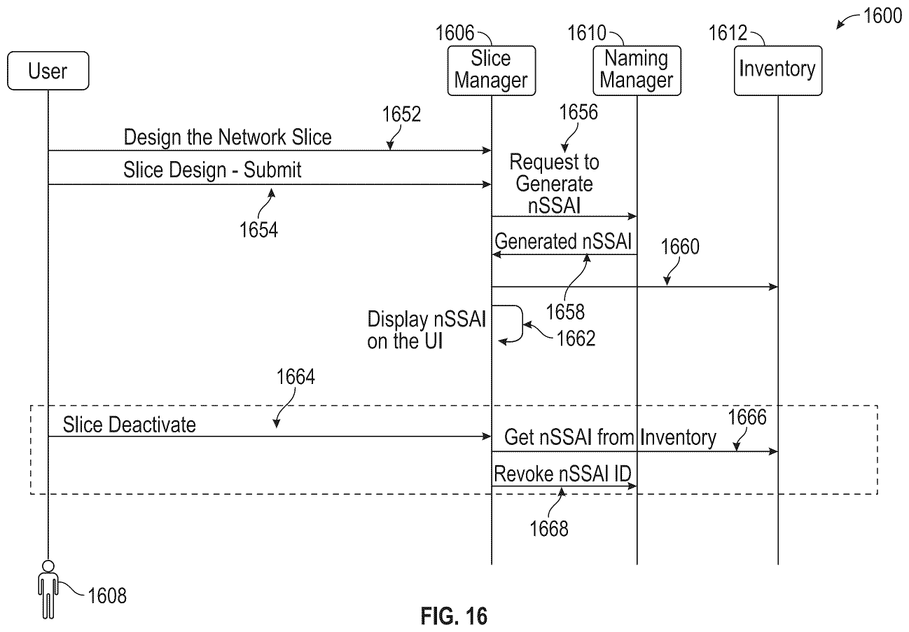

In some embodiments, NSDM 120 includes a naming manager (1610 FIG. 16) configured to automatically generate and implement a unique network slice identifier (UNSI). In some embodiments, naming manager 1610 generates a unique nSSAI ID whenever an API call is made from slice manager 1606 (FIG. 16) to naming manager 1610. In some embodiments, naming manager 1610 is a template-based rule engine, where user 1608 (FIG. 16) accesses a template rule where input parameters are stored, and naming manager 1610 generates and maintains the sequence of generated nSSAI IDs or names. In some embodiments, naming manager 1610 is configured to create rules and generate various nSSAI IDs, application names, or other functions within the scope of the embodiments.

A rule engine is a software system that executes one or more rules in a runtime production environment. The rules come from legal regulation, company policy, service level agreements (SLAs) with service providers 116, or other sources. A rule system enables company policies and other operational decisions to be defined, tested, executed, and maintained separately from application code. Rule engines typically support rules, facts, priority (score), mutual exclusion, preconditions, and other functions. Rule engine software is provided as a component of a business rule management system which, among other functions, provides the ability to: register, define, classify, and manage rules, verify consistency of rules definitions, define the relationships between different rules, and relate some of these rules to IT applications that are affected or need to enforce one or more of the rules.

Slice manager 1610 interfaces with the various functionalities performed by each layer (e.g., the service layer, the network function layer, and infrastructure layer) to coherently manage each slice request. Slice manager 1610 enables efficient and flexible slice creation that is reconfigurable. Slice manager 1610 provides end-to-end service management including mapping of various service instances, expressed in terms of SLA requirements, with suitable network functions capable of satisfying the service constraints. Slice manager provides slice life-cycle management, such as slice performance monitoring to dynamically reconfigure each slice to accommodate possible SLA requirements modifications.

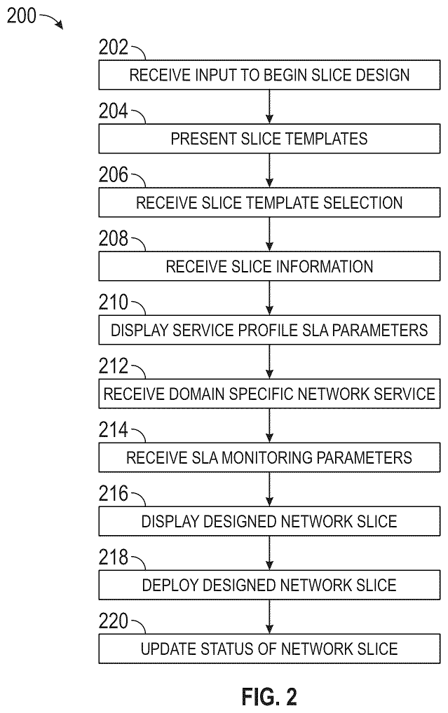

FIG. 2 is a flow diagram for a method of designing a network slice 200, in accordance with some embodiments.

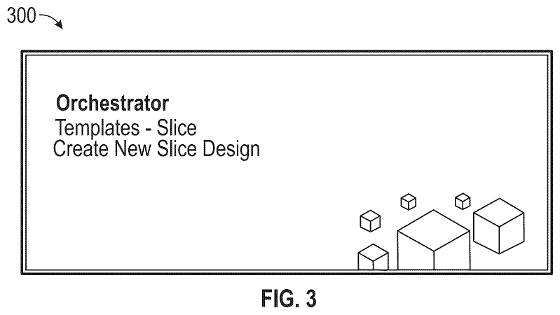

FIGS. 3-15 are graphic user interfaces (GUIs) 300-1500 for designing a network slice, in accordance with some embodiments.

In some embodiments, NSD method 200 describes process tasks of network slice design. While the operations of NSD method 200 are discussed and shown as having a particular order, each operation in NSD method 200 is configured to be performed in any order unless specifically called out otherwise. NSD method 200 is implemented as a set of operations, such as operations 202 through 220. Further, NSD method 200 is discussed with reference to FIGS. 3-15 to assist in the understanding of NSD method 200.

At operation 202 of NSD method 200, NSDM 120 receives an input from a user to begin network slice design. In some embodiments, the user is presented with GUI 300 indicating a network slice design application is starting. Process flows from operation 202 to operation 204.

At operation 204 of NSD method 200, NSDM 120 presents, through GUI 400, a list of slice templates 402. In some embodiments, each network slice in slice template list 402 includes a status (e.g., active, or inactive), a name, a slice service type (e.g., eMBB, uRLLC, mIoT, or custom), a service category (such as home automation, high speed train, or the like), a domain (RAN, TN, CN, or E2E), a vendor, version, shared (or not), created date, and last modified date. The term template refers to a feature of a software application that defines a unique non-executable file format intended specifically for that application. Process flows from operation 204 to operation 206.

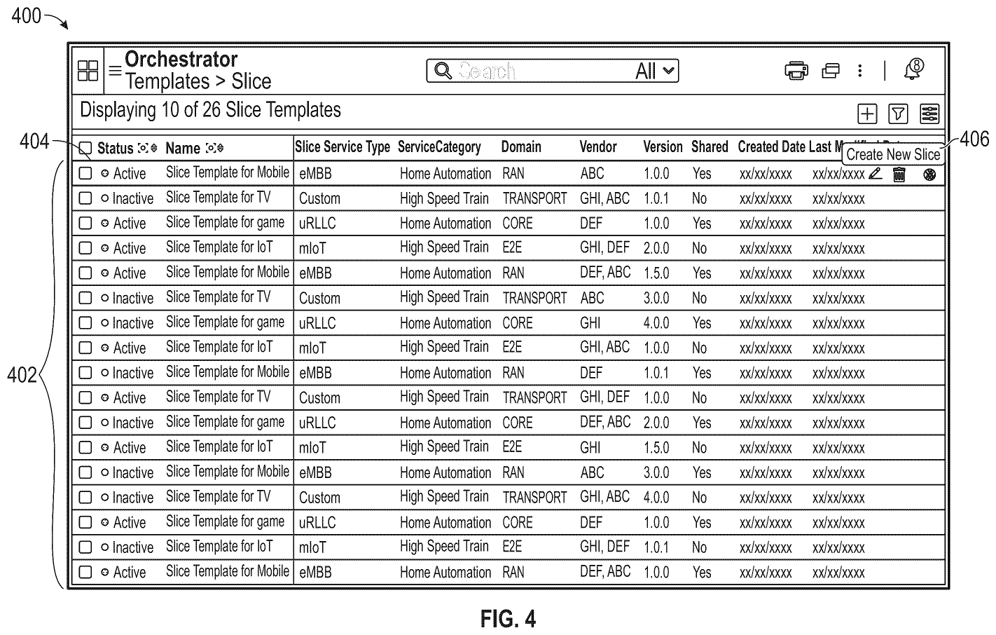

At operation 206 of NSD method 200, NSDM 120 receives a user input, through GUI 400, indicating a selection of a slice template. In FIG. 4, a user points to a slice template, for example slice template 404, then clicks on the slice template. Create new slice user selection button 406 pops up and the user clicks on user selection button 406 to begin the process of creating a new slice with the selected slice template. Process flows from operation 206 to operation 208.

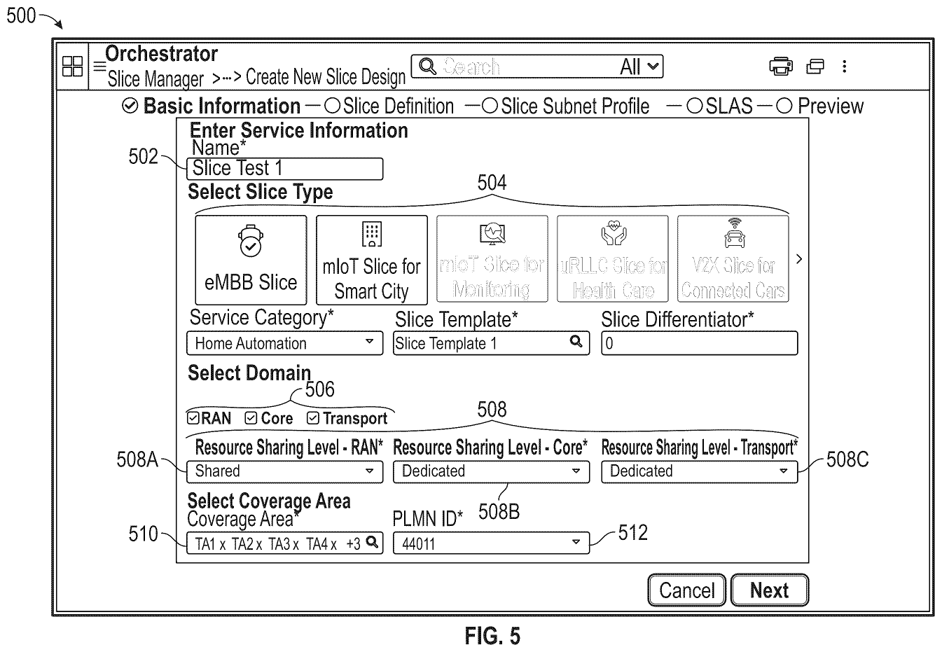

At operation 208 of NSD method 200, GUI 500 is presented, and the user inputs, through GUI 500, foundational slice information. In FIG. 5, a user inputs a slice name in user input field 502, selects a slice type from user selection field 504 (e.g., eMBB, URLLC type of slice, or the like), selects domains from user selection field 506, and selects whether the slice is shared or dedicated from user selection field 508. For example, the user selects a shared or dedicated slice subnet for each domain (RAN at user selection field 508A, core at user selection field 508B, transport at user selection field 508C, or a combination of each) and coverage area of the network slice at user selection field 510. Within user selection field 512, the PLMN is chosen. In some embodiments, the PLMN selection is based upon the coverage area selected in user selection field 510. Process flows from operation 208 to operation 210.

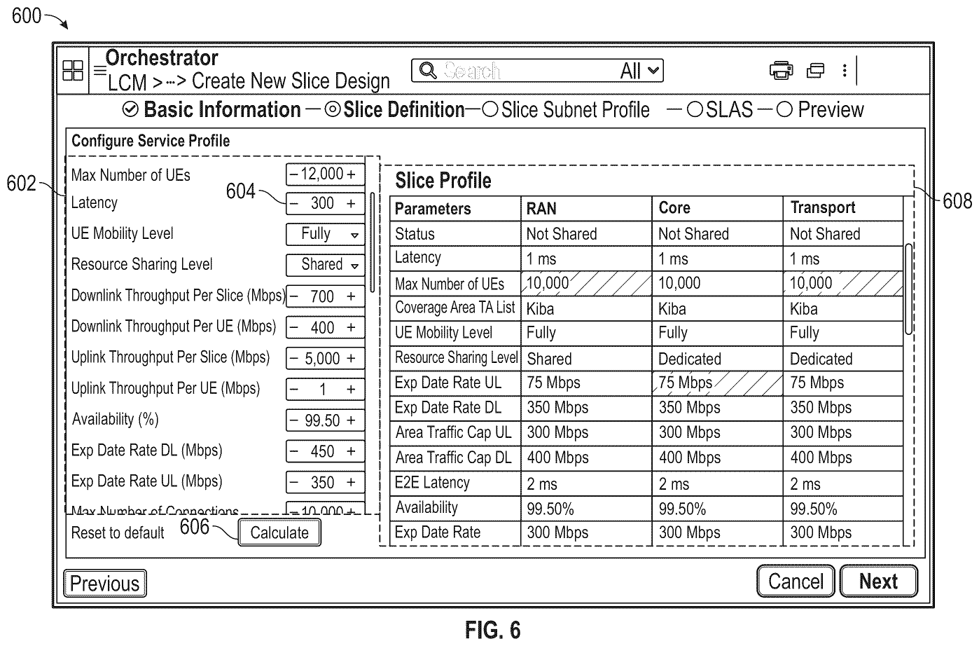

At operation 210 of NSD method 200, GUI 600 is presented, and the user sets network slice parameters. In FIG. 6, at slice parameter GUI 600, service profile SLA parameters 602 are presented and configured so the user is able to modify the parameters as applicable (e.g., according to an SLA). In a non-limiting example, a user modifies an expected latency to fit the specifications of the network slice at user selection field 604 (e.g., set at 300 ms). Once the user confirms all service profile parameters within parameter field 602, for the selected domain, the user points and clicks on calculate user selection button 606. In some embodiments, this process is repeated for each domain. A slice manager (1606 FIG. 16) calculates slice profile parameters (shown in slice profile box 608) of each domain (RAN, CORE, and transport) to meet service profile SLAs. Process flows from operation 210 to operation 212.

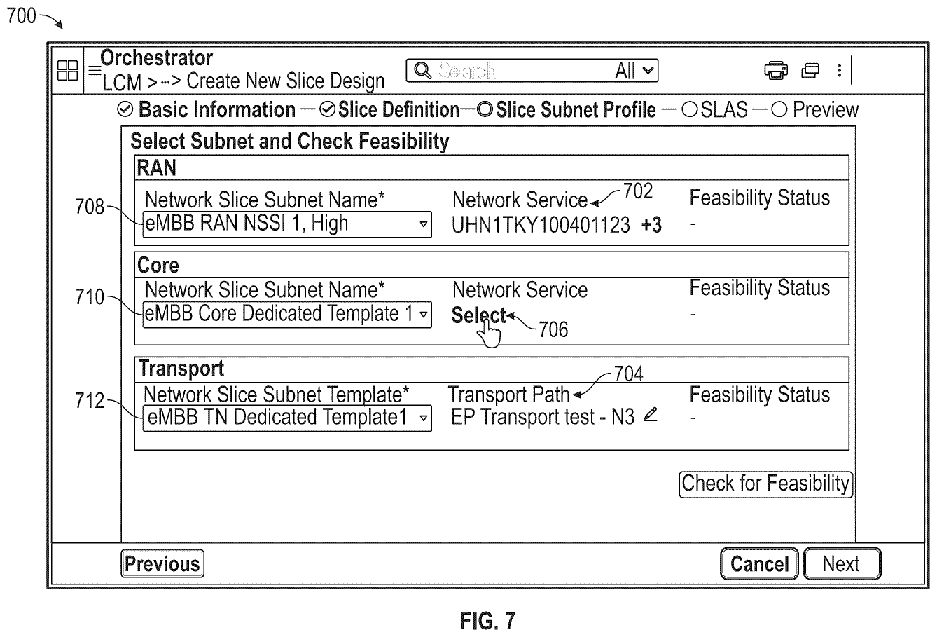

At operation 212 of NSD method 200, GUI 700 is presented, and the user selects a subnet profile, such as an already deployed domain specific network service (a shared network service or a dedicated network service). In FIG. 7, the user navigates to slice subnet profile GUI 700, where the user selects a network slice subnet name for each domain from user selection fields 708, 710, and 712. A network service associated with the slice subnet is displayed at locations 702 and 704. In response to a network service being absent or unassociated with the network slice subnet, the user is further able to select a network service template by pointing and clicking on select user selection field 706.

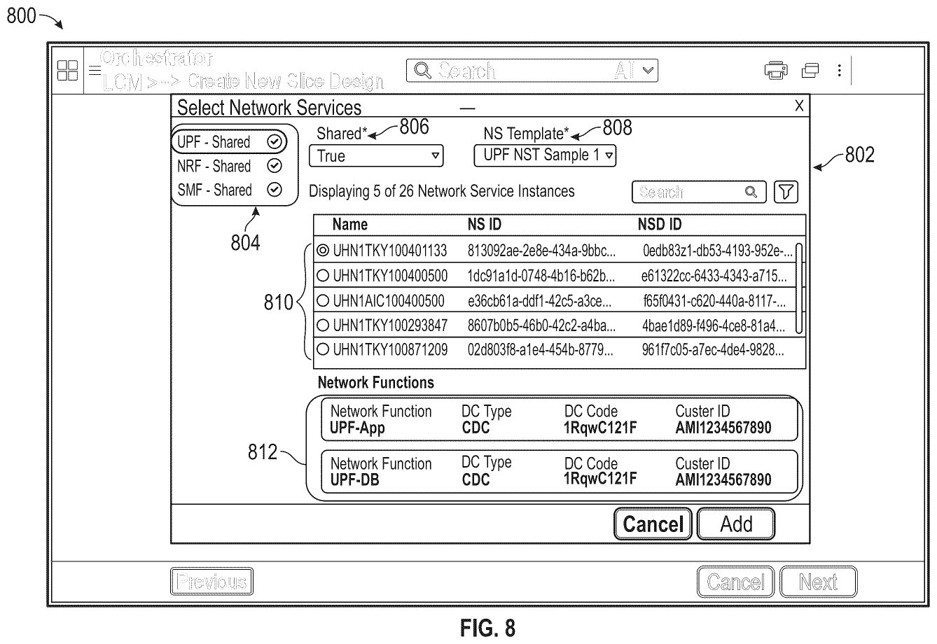

In FIG. 8, GUI 800 is presented after the user clicks on select user selection field 706, and the user is presented with a select network services pop-up box 802. As shown in network services box 804, each of the network services, such as user plane function (UPF is responsible for packet routing and forwarding, packet inspection, quality of service (QoS) handling, and external protocol data unit (PDU) session for interconnecting data network (DN) in a 5G architecture), network repository function (NRF acts as a central services broker for all network functions (NFs) in the 5G Core), or session management function (SMF is responsible for interacting with the decoupled data plane, creating updating and removing PDU sessions and managing session context with the UPF). In a non-limiting example, a user selects UPF (shown as highlighted) and within shared user input field 806 a user is presented with an indication (e.g., true) that the UPF network service is shared. A network services template name is displayed in user input field 808. A user selects network services from network services list 810. Box 812 displays the network functions associated with the selected network services selected by the user from network services list 810.

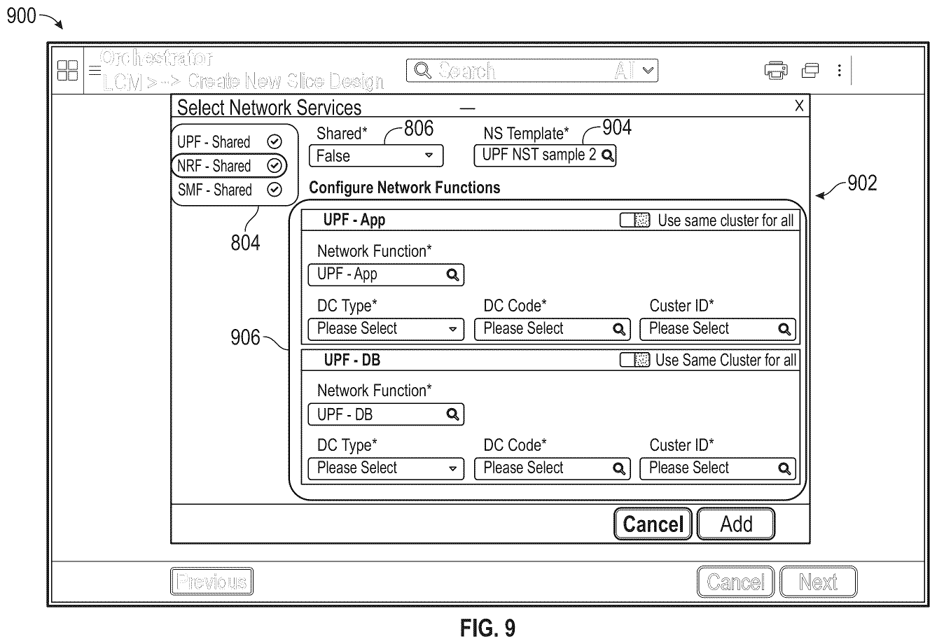

Alternatively, in FIG. 9, GUI 900 displays NRF as highlighted in network services box 804 and false is the indication presented within shared user input field 806 indicating the NRF network service is not shared. The user inputs network services information in template 902 for a dedicated network service. The user selects a network services template in NS template user selection field 904. In response to selection of a network service template (e.g., UPF NST sample 2), the user is presented with network functions box 906. In network functions box 906 the user selects a network function (such as UPF app and UPF DB where the user selects the distributed unit type, distributed unit code, and cluster ID).

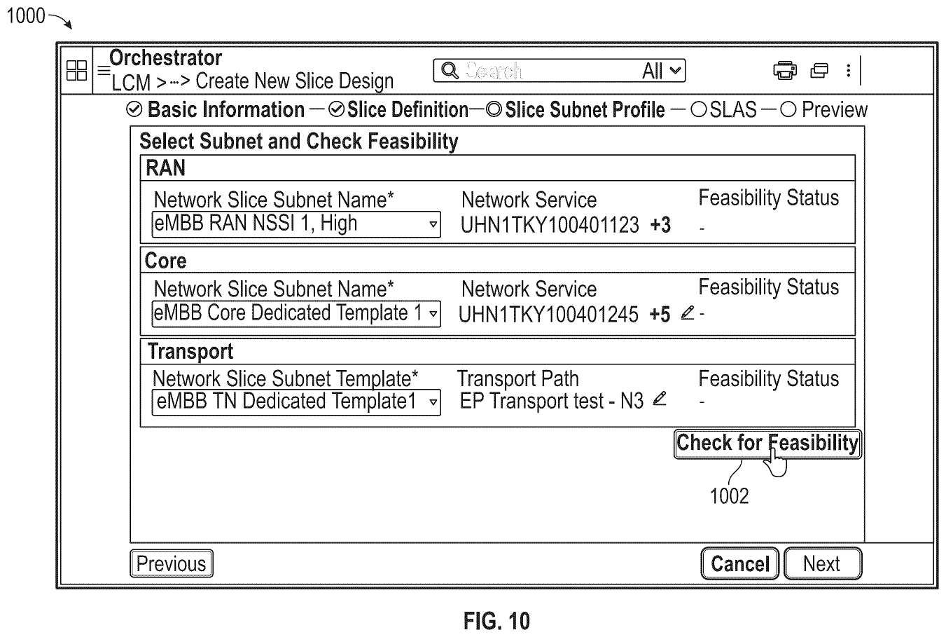

In FIG. 10, GUI 1000 is presented after each of the domains (RAN, core, and transport) include a network service. Once each domain includes a network service, the user points and clicks on feasibility user selection field 1002 and NSDM 120 determines whether the selected network services are ready to serve the new network slice.

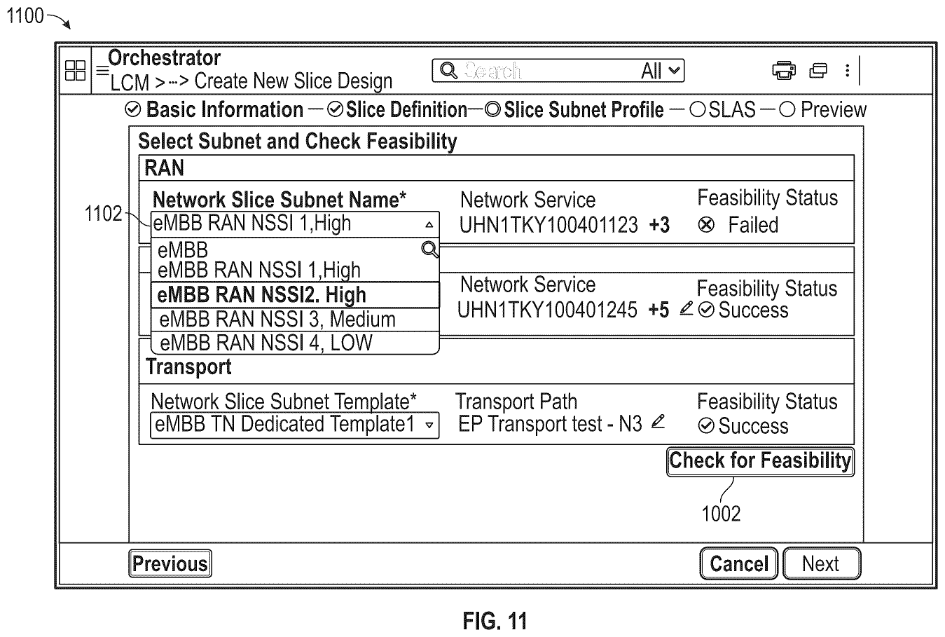

In FIG. 11, GUI 1100 is presented in response to the feasibility test failing for one or more domains (e.g., the RAN domain). The user clicks on network slice subnet name user selection field 1102 to select another slice subnet and recheck the feasibility by clicking on check for feasibility user selection field 1002.

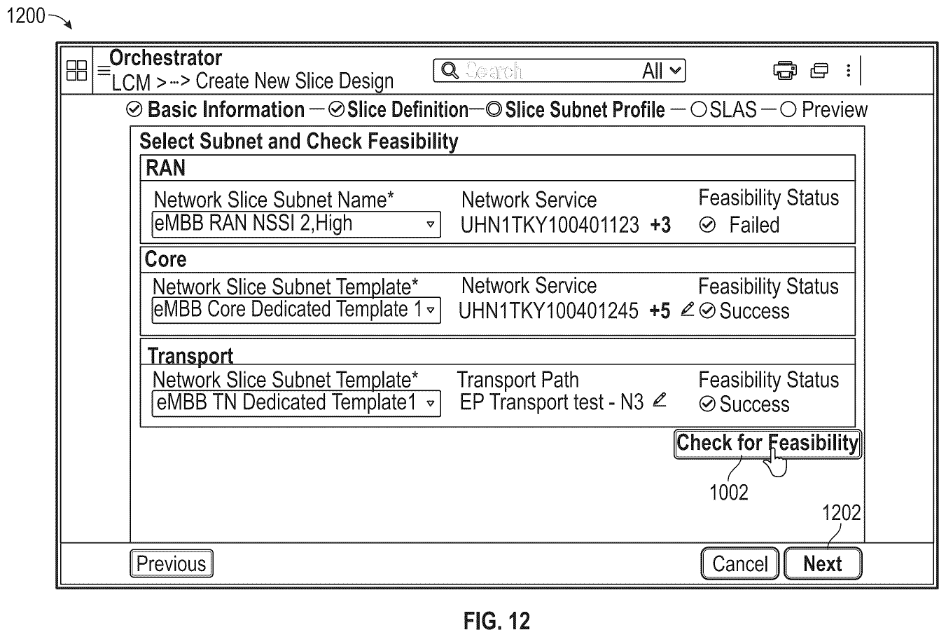

In FIG. 12, GUI 1200 is presented when the feasibility test is successful for each domain. In response to a successful feasibility test, the user clicks next user selection button 1202 to deploy the network slice. In some embodiments, without a successful feasibility test, the user is unable to move forward with the network slice design. Process flows from operation 212 to operation 214.

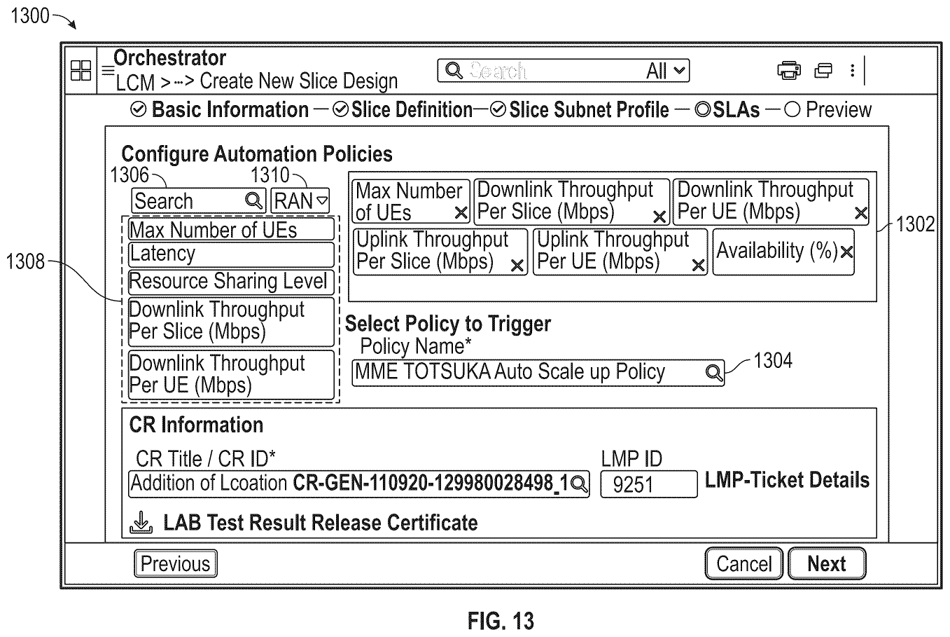

At operation 214 of method 200, GUI 1300 is presented (FIG. 13), and the user selects SLA parameters, such as parameters and KPIs shown in parameter box 1302, to be monitored for the network slice based on one or more SLA agreements. A user searches for parameters or KPIs within search user input field 1306 for a selected domain shown in user selection field 1310. In some embodiments, the user drags and drops parameters/KPIs from box 1308 to parameter/KPI box 1302. Further, in response to the slice being deployed and selection of parameters/KPIs (e.g., shown in box 1302) to be monitored, the user selects a policy, from policy name user selection field 1304 for slice automated healing use-cases. Auto healing is a function that automatically detects disabled access points and restores the wireless network. Process flows from operation 214 to operation 216.

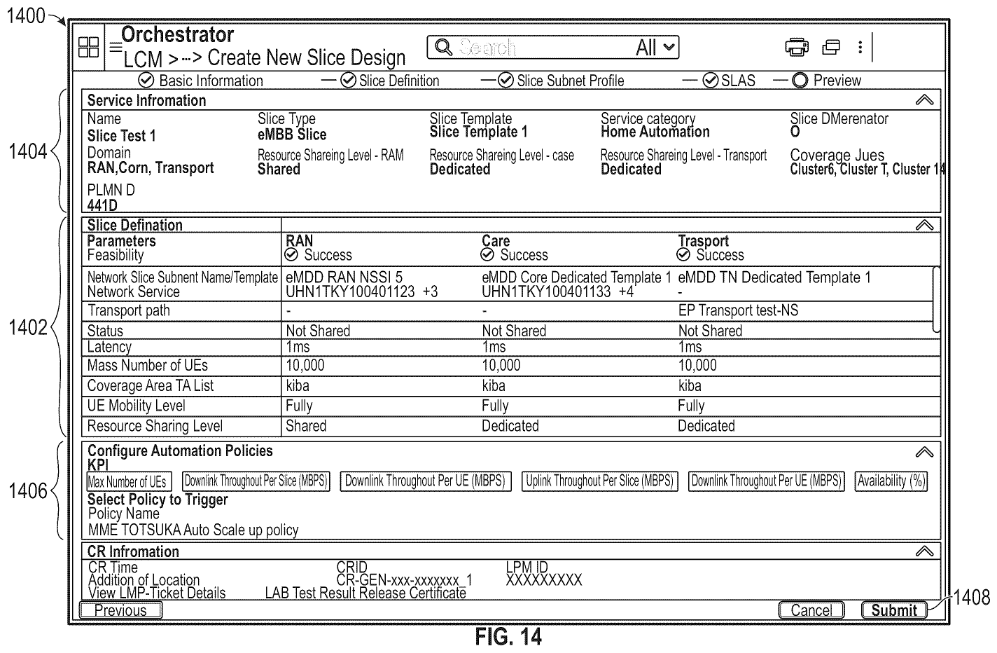

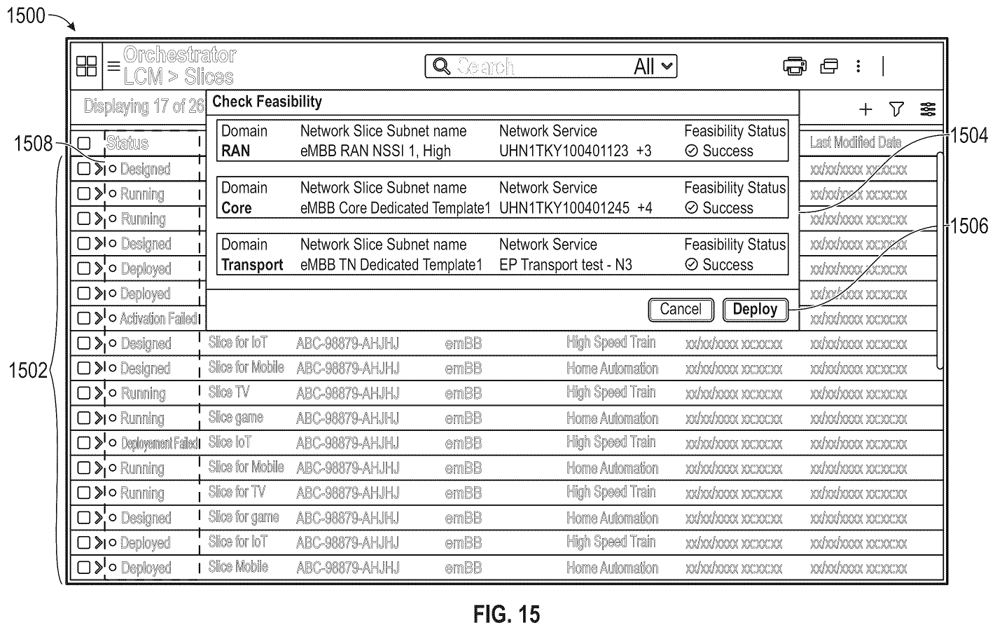

At operation 216 of method 200, designed network slice 1402 is displayed on GUI 1400 (FIG. 14) for the user's review. After previewing network slice 1402, including service information 1404 and automation policies 1406, the user clicks on submit user selection field 1408 after a determination the information is correct. In response to submit user selection field 1408 being clicked, GUI 1500 (FIG. 15) is displayed with a list of network slices 1502. Process flows from operation 216 to operation 218.

At operation 218 of method 200, a user deploys the designed network slice by clicking on the desired network slice in list of network slices 1502, which displays pop up box 1504 of GUI 1500. The user clicks on deploy user selection button 1506 to deploy the designed slice. In some embodiments, the slice manager (1606 FIG. 16) makes an API call to the orchestrator (not shown) and the designed slice is deployed. Process flows from operation 218 to operation 220.

At operation 220 of method 200, the status of the designed slice is updated. As seen in status box 1508, the status of the network slice is updated from designed to deployed. Other statuses include running, activation failed, deployment failed.

FIG. 16 is a data flow diagram of a method for generation and implementation of a unique network slice identifier (UNSI) 1600, in accordance with some embodiments.

Method for generation and implementation of a UNSI 1600 includes operations 1652-1668, but the operations are not necessarily performed in the order shown. Operations are added, replaced, order changed, and/or eliminated as appropriate, in accordance with the spirit and scope of disclosed embodiments. In some embodiments, one or more of the operations of method for generation and implementation of a UNSI 1600 are repeated. In some embodiments, unless specifically stated otherwise, the operations of method for generation and implementation of a UNSI 1600 are performed in order. In some embodiments, the operations of method for generation and implementation of a UNSI 1600 are performed by NSDM 120.

At operation 1652 of method for generation and implementation of a UNSI 1600, as discussed in FIGS. 2-15, user 1608, through GUIs 300-1500, designs a network slice. Process flows from operation 1652 to operation 1654.

At operation 1654 of method for generation and implementation of a UNSI 1600, the network slice is submitted by user 1608 to slice manager 1606 as discussed in operation 216 of method of designing a network slice 200. Process flows from operation 1604 to operation 1608.

At operation 1656 of method for generation and implementation of a UNSI 1600, in response to the designed network slice being designed and submitted, slice manager 1606 automatically makes an API call requesting naming manager 1610 generate an nSSAI ID. In some embodiments, naming manager 1610 is configured to take a business rule and implement the business rule in the form of a naming template where naming manager 1610 is responsible for creating an nSSAI ID output in sequence. Process flows from operation 1656 to operation 1658.

At operation 1658 of method for generation and implementation of a UNSI 1600, naming manager 1610 returns the generated nSSAI ID to slice manager 1606. In some embodiments, in response to a new network slice being designed at operation 1652, slice manager 1606 automatically makes an application programming interface (API) call to naming manager 1610 and receives an nSSAI ID for the newly designed network slice. In some embodiments, naming manager 1610 generates a unique nSSAI ID whenever an API call is made from slice manager 1606. In some embodiments, naming manager 1610 is a template-based rule engine. Within a rule template user 1608 accesses or creates a template rule where user 1608 inputs template parameters. Naming manager 1610 is configured to use the rule template to generate the nSSAI ID. In some embodiments, the rule template is a tool associated with the naming manager UI, where in response to the user, through the UI, clicking on Create Naming Rule Template user input field, the user determines the number of bits for the nSSAI ID, the number of bits input by the user, and the remaining bits input by the naming manager to keep the number sequencing, starting at 0 and incrementing with positive integers.

I think, discussing Naming Manager in more detail in this invention, might overlap with invention of Naming manager itself

Further, naming manager 1610 is configured to maintain a sequence of generated nSSAI IDs or names. In some embodiments, naming manager 1610 is configured to be used for creating the rule templates and generating various nSSAI IDs, application names, or other functions within the scope of the present embodiments. Process flows from operation 1658 to operation 1660.

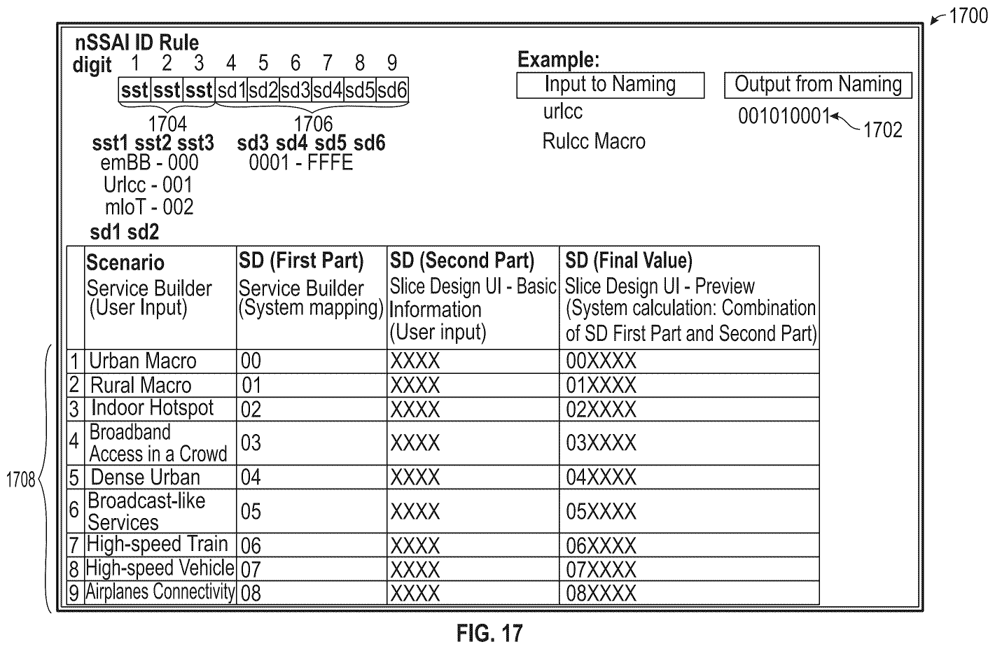

At operation 1660 of method for generation and implementation of a UNSI 1600, slice manager 1606 stores the NSSAI ID in inventory 1612. Inventory 1612 tracks nSSAI IDs which are distributed to network slices. As discussed in FIG. 17, the assigned nSSAI ID describes general configuration settings for each network slice. Process flows from operation 1660 to operation 1662.

At operation 1662 of method for generation and implementation of a UNSI 1600, slice manager 1606 displays the new nSSAI on the UI, such as UI 1822 (FIG. 18), for user 1608. Process, optionally, flows from operation 1662 to operation 1664.

At operation 1664 of method for generation and implementation of a UNSI 1600, slice manager receives a request from user 1608 to deactivate a network slice. Process flows from operation 1664 to operation 1666. In a non-limiting example, in response to a customer unwanted slice, in response to the customer expecting to deactivate the current slice and look to order a new slice with new capacity, or in response to a slice causing issues in the network, the user is able to deactivate the slice.

At operation 1666 of method for generation and implementation of a UNSI 1600, slice manager requests the network slice to be deactivated from inventory 1612. Process flows form operation 1666 to operation 1668.

At operation 1666 of method for generation and implementation of a UNSI 1600, where the slice manager 1606 makes an API call to naming manager 1610 and requests to revoke the nSSAI ID from naming manager 1610 so that the deactivated nSSAI ID is reusable for a new slice. In the event the network slice is deactivated or terminated, then slice manager 1606 makes another API call to naming manager 1610 and requests the revocation of that nSSAI ID from naming manager 1610, so the terminated or deactivated nSSAI ID is reusable for another slice.

FIG. 17 is an example nSSAI ID rule 1700, in accordance with some embodiments.

S-NSSAI ID 1702 is used to uniquely identify a network slice. In the example of FIG. 17, a an ultra reliable low latency communications (URLCC) service type with a rural macro network service (e.g., a base station, such as base station 108 in a rural area). S-NSSAI ID 1702 contains two components, SST (Slice/Service Type) 1704 and an optional SD (Slice Differentiator) 1706. In relation to network slicing, SST 1704 is the expected behavior of the network slice in terms of specific features and services. Standardized SST values include eMBB (enhanced mobile broadband which focuses on the high speed of end user data and system capacity), URLLC (ultra-reliable low latency communications is a subset of the 5G network architecture that ensures efficient scheduling of data transfers, achieving shorter transmissions through a larger subcarrier, and even scheduling overlapping transmissions) and MIoT (massive internet of things is a category driven by scale rather than speed where deployments include anywhere from hundreds to billions of connected devices where the goal for these applications is to efficiently transmit and consume small amounts of data from vast numbers of devices). In network slicing, SD 1706 is related to SST 1716 and is used as an additional differentiator when multiple network slices carry the same SST value. SD 1706 is directed to the implementation of the network slice.

An nSSAI ID typically has a total length of nine characters where the first three characters are SST 1704 and the remaining six characters are SD 1706. In some embodiments, naming manager 1610 is configured to take a business rule and implement the business rule in the form of a naming template where naming manager 1610 is responsible for creating an nSSAI ID output in sequence. In a non-limiting example, in response to the first slice including the nSSAI ID as 00001, then in the second slice, the nSSAI ID would be 00002, and for the third slice, the nSSAI ID would be 00003.

In some embodiments, eMBB includes an SST of 000, URLLC includes an SST of 001, and MIoT includes an SST of 002. In example nSSAI ID 1702, the SST is shown as a URLLC. Thus, example nSSAI ID is designed for efficient scheduling of data transfers, achieving shorter transmissions through a larger subcarrier, and scheduling overlapping transmissions. In service builder list 1708, several options for URLLC are presented, such as, urban macro service, rural macro service, indoor hotspot service, broadband access in a crowd service, dense urban service, broadcast-like services, high-speed train services, high-speed vehicle services, and airplane connectivity services.

From example nSSAI ID 1702, the first two digits of SD 1706 (e.g., sd1 and sd2) show that the SD of nSSAI ID 1702 is set for a rural macro service. The remaining SD digits (e.g., sd3, sd4, sd5, and sd6) are configured to be used to designate network functions. In the current example, there are 0001-FFFE (65,535) possible network functions for each service within service builder 1708.

FIG. 18 is a block diagram of network slice design (NSD) processing circuitry 1800 in accordance with some embodiments. In some embodiments, NSD processing circuitry 1800 is a general-purpose computing device including a hardware processor 1802 and a non-transitory, computer-readable storage medium 1804. Storage medium 1804, amongst other things, is encoded with, i.e., stores, computer program code 1806, i.e., a set of executable instructions such as an algorithm, or methods 200 and 1600. Execution of instructions 1806 by hardware processor 1802 represents (at least in part) a network slice design application which implements a portion, or all the methods described herein in accordance with one or more embodiments (hereinafter, the noted processes and/or methods).

Processor 1802 is electrically coupled to a computer-readable storage medium 1804 via a bus 1808. Processor 1802 is further electrically coupled to an I/O interface 1810 by bus 1808. A network interface 1812 is further electrically connected to processor 1802 via bus 1808. Network interface 1812 is connected to a network 1814, so that processor 1802 and computer-readable storage medium 1804 connect to external elements via network 1814. Processor 1802 is configured to execute computer program code 1806 encoded in computer-readable storage medium 1804 to cause NSD processing circuitry 1800 to be usable for performing a portion or all the noted processes and/or methods. In one or more embodiments, processor 1802 is a central processing unit (CPU), a multi-processor, a distributed processing system, an application specific integrated circuit (ASIC), and/or a suitable processing unit.

In one or more embodiments, computer-readable storage medium 1804 is an electronic, magnetic, optical, electromagnetic, infrared, and/or a semiconductor system (or apparatus or device). For example, computer-readable storage medium 1804 includes a semiconductor or solid-state memory, a magnetic tape, a removable computer diskette, a random-access memory (RAM), a read-only memory (ROM), a rigid magnetic disk, and/or an optical disk. In one or more embodiments using optical disks, computer-readable storage medium 1804 includes a compact disk-read only memory (CD-ROM), a compact disk-read/write (CD-R/W), and/or a digital video disc (DVD).

In one or more embodiments, storage medium 1804 stores computer program code 1806 configured to cause NSD processing circuitry 1800 to be usable for performing a portion or all the noted processes and/or methods. In one or more embodiments, storage medium 1804 further stores information, such as an algorithm which facilitates performing a portion or all the noted processes and/or methods.

NSD processing circuitry 1800 includes I/O interface 1810. I/O interface 1810 is coupled to external circuitry. In one or more embodiments, I/O interface 1810 includes a keyboard, keypad, mouse, trackball, trackpad, touchscreen, and/or cursor direction keys for communicating information and commands to processor 1802.

NSD processing circuitry 1800 further includes network interface 1812 coupled to processor 1802. Network interface 1812 allows NSD processing circuitry 1800 to communicate with network 1814, to which one or more other computer systems are connected. Network interface 1812 includes wireless network interfaces such as BLUETOOTH, WIFI, WIMAX, GPRS, or WCDMA; or wired network interfaces such as ETHERNET, USB, or IEEE-864. In one or more embodiments, a portion or all noted processes and/or methods, are implemented in two or more processors 1802.

NSD processing circuitry 1800 is configured to receive information through I/O interface 1810. The information received through I/O interface 1810 includes one or more of instructions, data, rules, and/or other parameters for processing by processor 1802. The information is transferred to processor 1802 via bus 1808. NSD processing circuitry 1800 is configured to receive information related to UI 1822 through I/O interface 1810. The information is stored in computer-readable medium 1804 as user interface (UI) 1822.

In some embodiments, a portion or all the noted processes and/or methods is implemented as a standalone software application for execution by a processor. In some embodiments, a portion or all the noted processes and/or methods is implemented as a software application that is a part of an additional software application. In some embodiments, a portion or all the noted processes and/or methods is implemented as a plug-in to a software application.

In some embodiments, a method includes creating, by a processor and based on a network slice design submitted by a user, a network slice; and generating, automatically by the processor, a network slice selection assistance information ID (nSSAI ID) for the network slice.

In some embodiments, before the creating the network slice, the method further includes receiving the network slice design submitted by a user.

In some embodiments, the method further includes storing, by the processor, the nSSAI ID.

In some embodiments, the method further includes displaying, by the processor, the nSSAI ID on a graphical user interface (GUI) included with a user interface (UI).

In some embodiments, the method further includes receiving, by the processor, a request to deactivate the network slice.

In some embodiments, the method further includes retrieving, by the processor, the network slice from storage.

In some embodiments, the method further includes deactivating, by the processor, the network slice.

In some embodiments, the method further includes reusing, by the processor, the network slice as another network slice.

In some embodiments, an apparatus includes a processor; and a memory having instructions stored thereon that, when executed by the processor, cause the processor to create, based on a network slice design submitted by a user, a network slice; and generate, automatically based on the network slice design, a network slice selection assistance information ID (nSSAI ID) for the network slice.

In some embodiments, before the creating the network slice, the instructions further cause the processor to receive the network slice design submitted by a user.

In some embodiments, the instructions further cause the processor to store the nSSAI ID.

In some embodiments, the instructions further cause the processor to display the nSSAI ID on a graphical user interface (GUI) included with a user interface (UI).

In some embodiments, the instructions further cause the processor to receive a request to deactivate the network slice.

In some embodiments, the instructions further cause the processor to retrieve the network slice from storage.

In some embodiments, the instructions further cause the processor to deactivate the network slice.

In some embodiments, the instructions further cause the processor to reuse the network slice as another network slice.

In some embodiments, a non-transitory computer readable medium having instructions stored thereon that, when executed by a processor, cause the processor to create, based on a network slice design submitted by a user, a network slice; and generate, automatically based on the network slice design, a network slice selection assistance information ID (nSSAI ID) for the network slice.

In some embodiments, before the creating the network slice, the instructions further cause the processor to receive the network slice design submitted by a user.

In some embodiments, the instructions further cause the processor to store the nSSAI ID.

In some embodiments, the instructions further cause the processor to display the nSSAI ID on a graphical user interface (GUI) included with a user interface (UI).

The foregoing outlines features of several embodiments so that those skilled in the art better understand the aspects of the present disclosure. Those skilled in the art should appreciate that they readily use the present disclosure as a basis for designing or modifying other processes and structures for conducting the same purposes and/or achieving the same advantages of the embodiments introduced herein. Those skilled in the art should further realize that such equivalent constructions do not depart from the spirit and scope of the present disclosure, and that they make various changes, substitutions, and alterations herein without departing from the spirit and scope of the present disclosure.

What is claimed is:

1. A method comprising:
creating, by a processor and based on a network slice design submitted by a user, a network slice; and
generating, automatically by the processor, a network slice selection assistance information ID (nSSAI ID) for the network slice.

2. The method of claim 1, wherein before the creating the network slice, the method further comprising:
receiving the network slice design submitted by a user.

3. The method of claim 1, further comprising:
storing, by the processor, the nSSAI ID.

4. The method of claim 1, further comprising:
displaying, by the processor, the nSSAI ID on a graphical user interface (GUI) included with a user interface (UI).

5. The method of claim 1, further comprising:
receiving, by the processor, a request to deactivate the network slice.

6. The method of claim 5, further comprising:
retrieving, by the processor, the network slice from storage.

7. The method of claim 6, further comprising:
deactivating, by the processor, the network slice.

8. The method of claim 7, further comprising:
reusing, by the processor, the network slice as another network slice.

9. An apparatus, comprising:
a processor; and
a memory having instructions stored thereon that, when executed by the processor, cause the processor to:
create, based on a network slice design submitted by a user, a network slice; and
generate, automatically based on the network slice design, a network slice selection assistance information ID (nSSAI ID) for the network slice.

10. The apparatus of claim 9, wherein before the creating the network slice, the instructions further cause the processor to:
receive the network slice design submitted by a user.

11. The apparatus of claim 9, wherein the instructions further cause the processor to:
store the nSSAI ID.

12. The apparatus of claim 9, wherein the instructions further cause the processor to:
display the nSSAI ID on a graphical user interface (GUI) included with a user interface (UI).

13. The apparatus of claim 9, wherein the instructions further cause the processor to:
receive a request to deactivate the network slice.

14. The apparatus of claim 13, wherein the instructions further cause the processor to:
retrieve the network slice from storage.

15. The apparatus of claim 14, wherein the instructions further cause the processor to:
deactivate the network slice.

16. The apparatus of claim 15, wherein the instructions further cause the processor to:
reuse the network slice as another network slice.

17. A non-transitory computer readable medium having instructions stored thereon that, when executed by a processor, cause the processor to:
create, based on a network slice design submitted by a user, a network slice; and
generate, automatically based on the network slice design, a network slice selection assistance information ID (nSSAI ID) for the network slice.

18. The non-transitory computer readable medium of claim 17, wherein before the creating the network slice, the instructions further cause the processor to:
receive the network slice design submitted by a user.

19. The non-transitory computer readable medium of claim 17, wherein the instructions further cause the processor to:
store the nSSAI ID.

20. The non-transitory computer readable medium of claim 17, wherein the instructions further cause the processor to:
display the nSSAI ID on a graphical user interface (GUI) included with a user interface (UI).
